(19) United States
(12) Patent Application Publication
(10) Pub. No.: US 2006/0180034 A1
(43) Pub. Date: Aug. 17, 2006

(54) Removable heat shield for forming a pattern on toast

(76) Inventor: Karsten Achim Richard Arend, Toronto (CA)

Correspondence Address: SAND & SEBOLT, AEGIS TOWER, SUITE 1100, 4940 MUNSON STREET, NW, CANTON, OH, 44718-3615, US

(21) Appl. No.: 11/058,795

(22) Filed: Feb. 16, 2005

(51) Int. Cl. A47J 37/08

(52) U.S. Cl. 99/389

(57) ABSTRACT

A removable heat shield for creating a replica of a design on a baked product as it is toasted in a toaster. The heat shield comprises a single L-shaped panel being a body with a flange extending outwardly from a front surface of the body and substantially at ninety degrees thereto. The body includes a decorative design formed by one or more continuous areas being decoratively arranged with one or more apertured areas. The heat shield is removably inserted into the slot of a toaster so that the flange rests on the movable carriage and the baked product is inserted into the toaster and rests on the flange. When the toaster heats up, the continuous areas of the shield prevent radiated heat from reaching those portions of the baked product immediate adjacent to the continuous areas and substantially prevent them from toasting. The apertured areas of the shield allow heat to radiate through to those portions of the baked product adjacent the apertured areas and these portions of the product become toasted. The design is thereby toasted into the outer surface of the baked product. The shield may include a handle for raising and lowering of the shield into the slot of a toaster.

### BACKGROUND OF THE INVENTION

1. Technical Field

This invention generally relates to toasters. More particularly, the invention relates to a device for creating a pattern on bread as it is toasted. Specifically, the invention relates to a removable heat shield which includes a design formed from a one or more continuous areas decoratively arranged with one or more apertured areas which selectively allow heat from the toaster element to reach the bread, thereby forming a pattern on the bread as it toasts.

2. Background Information

Toasters are used to heat up and crisp bread and other baked goods therein by browning substantially the entire outer surface of the product.

It has been known in the prior art to provide toasters which impart a pattern to a slice of bread as it is browned by the toaster. The pattern imparted thereto increases the aesthetic appeal of the toasted bread, especially for children. An example of such a toaster is that disclosed in U.S. Pat. No. 5,156,637 to Wai-Ching. This patent discloses that a baking panel may be secured within the toaster. The baking panel includes cut out portions which may take the form of an animal character's face. As the toaster's elements heat up, heat can only pass through the cut out portions of the baking panel.

Consequently the shape of the animal character's face is toasted onto the bread and the remaining outer surface of the bread is untoasted.

Another toaster including a patterned baking panel is that disclosed in U.S. Pat. No. 5,943,948 to Tanaka. In this patent, the patterned baking panel is permanently secured to a recessed heater guard within the toaster so that the panel does not interfere with the bread slices as they are inserted into the toaster slot. The patterned baking panel includes a shape which shields certain areas on the bread from the heating element. The shape on the baking panel therefore prevents those certain areas on the bread from being toasted.

U.S. Pat. No. 6,112,648 to Origane also includes a patterned baking panel permanently secured to the heater guards within the toaster slot and further includes a device for forcing thinner slices of bread into close proximity with the patterned baking panel so that a clear pattern is toasted thereon.

U.S. Pat. No. 4,290,349 to Fiorenza discloses a removable toaster accessory which may include decorated inserts for making patterns on the surface of the bread being toasted therein. The accessory comprises a pair of mesh side panels which are hinged together at one end and may be secured together at the other end. The decorative pattern is secured to the mesh of the side panels and effectively prevents heat from toasting that portion of the bread which lies behind the pattern. One of the disadvantages of this accessory is that it decreases in internal depth from the top of the device to the bottom of the device. Consequently, the lowermost region of the accessory will tend to squash the slice of bread held therein. Furthermore, this decreasing interior depth will cause crumbs from the bread to become lodged therein, thereby making it difficult to keep this accessory clean. Yet another disadvantage of this device is that the accessory has to be entirely removed from the toaster once a slice of bread is toasted and the hot accessory has to be manipulated in order to remove the toast therefrom. This increases the chance that the user will burn their hands trying to remove their toast from the accessory.

Finally, U.S. Pat. No. 4,656,927 to Mosby et al, discloses a C-shaped removable accessory for a toaster which includes a patterned area for shielding part of a slice of bread from the heat in the toaster, thereby resulting in a pattern being formed on the slice of bread. This accessory includes a bottom wall and two side walls which extend upwardly therefrom. The side walls include the patterned area or may be set up to receive slidable patterned panels therein. A handle is connected to the side walls to allow the accessory to be raised from and lowered into the toaster. Again, the design of this accessory will allow crumbs from the slice of bread to accumulate on the bottom wall thereof making it hard to clean. Another disadvantage of this product is that each time a slice of bread is toasted the entire toaster accessory has to be removed from the toaster in order to access the toast. Furthermore, the user has to manipulate the hot accessory in order to remove the toast from the device and this increases the risk of the user burning their hands.

There is therefore a need in the art for a toaster accessory which allows a pattern to be formed on a baked product as it is toasted, but which is simple and easy to use and clean.

### SUMMARY OF THE INVENTION

The device of the present invention is a removable heat shield which is inserted into the slot of a toaster to form a pattern on a slice of bread as it toasts. The heat shield comprises a single L-shaped panel comprising a body with a flange extending outwardly away therefrom. The flange rests on the movable carriage within a toaster slot and is adapted to the baked product thereon. The shield may also include an upper flange which acts as a handle. The upper and lower flanges extend outwardly from the body in substantially opposite directions. The body includes an aesthetically pleasing design which is formed by a plurality of different continuous and apertured areas in the body. When the toaster heats up, the continuous areas of the heat shield prevent areas of the slice of bread from toasting and the apertured portions of the heat shield allow other areas of the bread to become toasted. In this way, a replica of the design is toasted onto the slice of bread or other baked product. The advantages of this device include that it does not need to be removed from the toaster in order to access the toast. When the toaster functions in its usual manner, the toast is just as accessible to the user as would be the case if the instant device was not present. Furthermore, the device includes a single lower flange upon which the slice of bread rests. Crumbs can therefore be easily removed from the device by simply tipping the device to allow the crumbs to slide off the flange or by wiping the flange with a cloth.

### BRIEF DESCRIPTION OF THE DRAWINGS

The preferred embodiments of the invention, illustrative of the best mode in which applicant has contemplated applying the principles, are set forth in the following description and are shown in the drawings and are particularly and distinctly pointed out and set forth in the appended claims.

FIG. 1 is a perspective view of the heat shield of the present invention;

FIG. 2 is a front view of the heat shield of FIG. 1;

FIG. 3 is a side view of the heat shield of FIG. 1;

FIG. 4 is a perspective view showing the heat shield and baked product being lowered into a toaster;

FIG. 5 is a cross-sectional side view of the toaster showing the position of the heat shield when the shield is held within the slot of a toaster when not in operation; and

FIG. 6 is a cross-sectional side view of the toaster showing the position of the heat shield and baked product when the shield is held within the slot of the toaster and the toaster is activated.

### DETAILED DESCRIPTION OF THE INVENTION

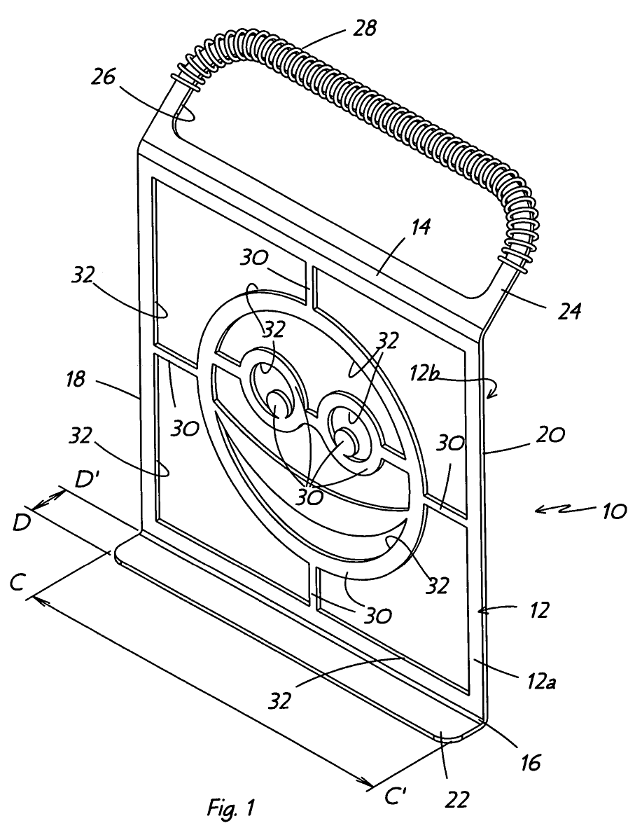

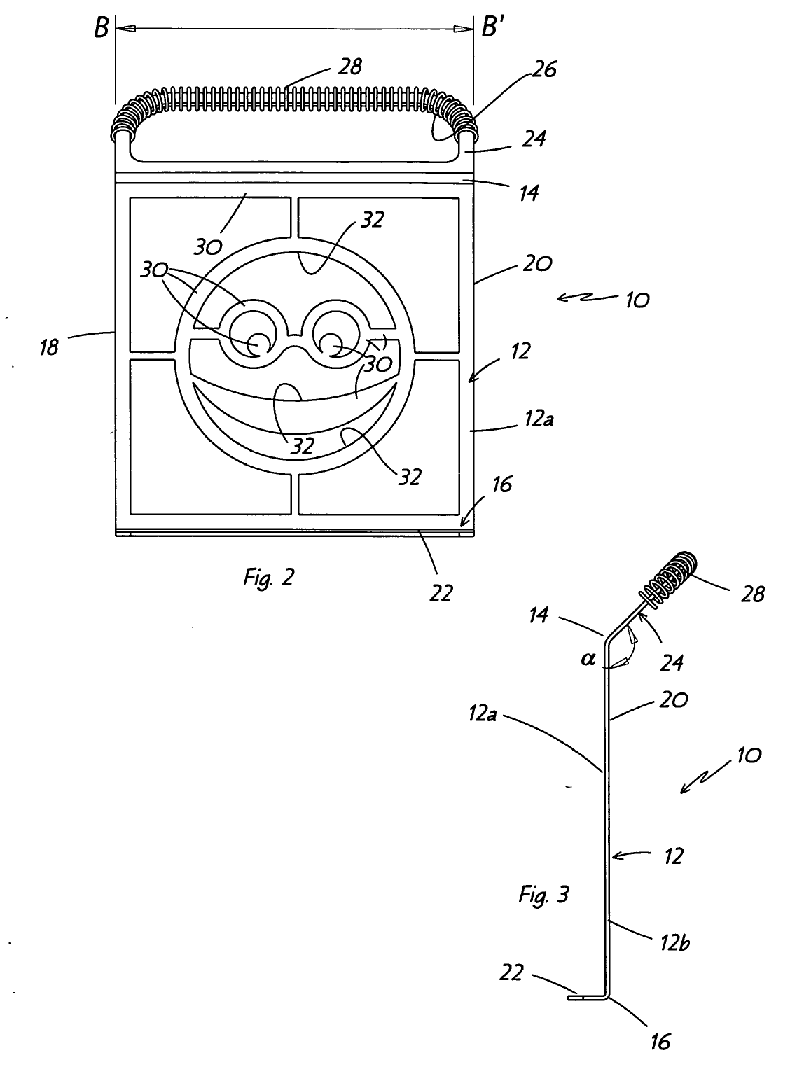

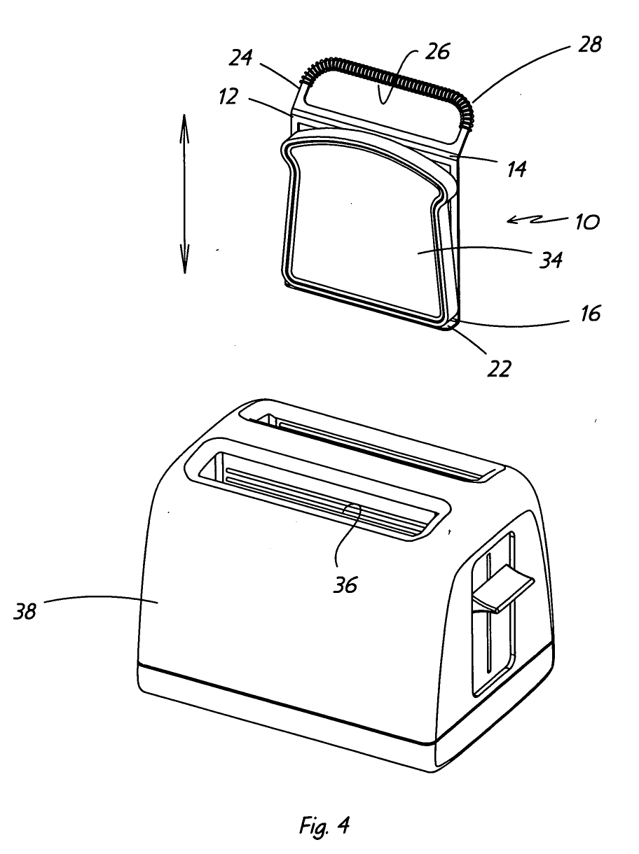

Referring to FIGS. 1-3 there is shown a heat shield for creating a pattern on previously baked products, such as slices of bread, said shield being generally indicated at 10. Heat shield 10 comprises a single, L-shaped panel comprising a body 12 and a first flange 22. Body 12 is manufactured from a metal or a heat-resistant plastic and is defined by an upper edge 14, a lower edge 16 and opposing sides 18, 20. Body 12 has a front surface 12a and a rear surface 12b and is of a width B-B+ (FIG. 2) which extends between sides 18 and 20.

First flange 22 extends outwardly away from front surface 12a of body 12, proximate the lower edge 16 thereof and at substantially 90° to front surface 12a. First flange 22 has a length C-C′ (FIG. 1) and a width D-D′. Length C-C′ of first flange 22 is substantially equal to the width B-B′ of body 12, but may alternatively be shorter than width B-B′, provided it is sufficiently long enough to support a baked product, such as a slice of bread, thereon.

A second flange 24 extends outwardly away from rear surface 12b of body 12 and proximate the upper edge 14 thereof. Second flange extends outwardly away from rear surface 12b at an “α” thereto. The angle “α” is between 0° and 90° and preferably is 45°. Second flange 24 includes an aperture 26 therein and includes insulating material 28 wrapped around at least a portion thereof. Second flange 24 can therefore be used as a handle to raise and lower shield 10 into and out of a toaster as will be hereinafter described. It will be understood that the body 12, first flange 22 and second flange 24 are all substantially flat components. The body 12 may be stamped from metal and the first and second flanges 22, 24 simply bent in opposite directions until they are configured as shown in the attached drawings. Body 12, first flange 22 and second flange 24 preferably are integrally formed.

In accordance with one of the specific features of the present invention, body 12 includes a decorative design therein, the design being formed from a plurality of continuous areas 30 and apertured areas 32. The continuous areas 30 and apertured areas 32 are arranged to form a pattern or picture, such as the smiley-face shown in FIGS. 1-2. Heat is able to travel through apertured areas 32 but is substantially prevented from flowing through the continuous areas 30 of shield 10.

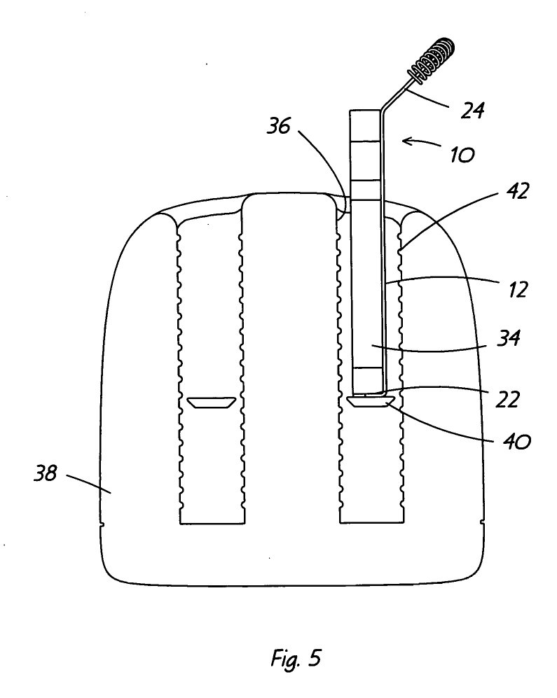

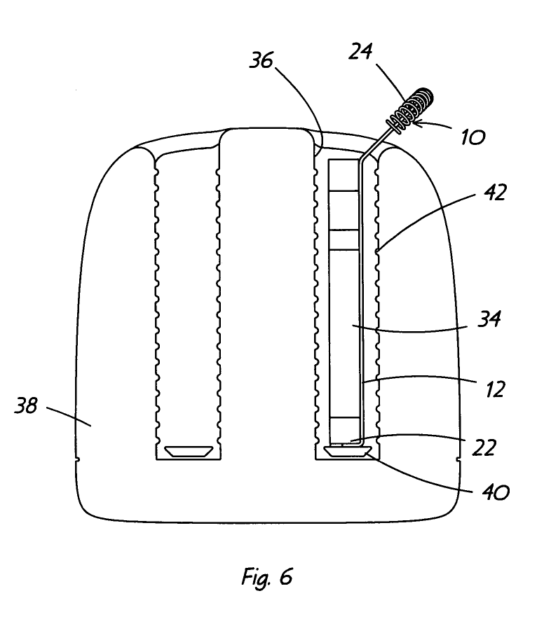

Referring to FIGS. 4-6, the heat shield 10 is used in the following manner to toast an image onto a previously baked product such as a slice of bread 34. Shield 10 is receivable within the slot 36 of a toaster, and more specifically a pop-up toaster 38. Width D-D′ of first flange 22 of shield 10 is large enough to support slice of bread 34 thereon, but is also small enough to be received into the slot 36. First flange 22 rests on a movable carriage 40 (FIG. 5) which rides up and down within slot 36. Slice of bread 34, may be inserted into slot 36 in one of two ways. Firstly, shield 10 may be entirely removed from toaster 38 (as is shown in FIG. 4). Slice of bread 34 is placed onto first flange 22 and heat shield 10 is lowered into slot 36 of toaster 38 using second flange 24 as a handle. Alternatively, shield 10 is inserted into slot 36 and then slice of bread 34 may be slipped into slot 36 of toaster 38 in the same manner as a consumer would place any slice of bread into the slot 36 if the shield 10 were not present. When toaster 38 is activated, the movable carriage 40 is moved from a first position (FIG. 5) where the element 42 is not drawing current, to a second position (FIG. 6) where element 42 is drawing current and heats up. When the carriage 40 is in the second position, body 12 lies between element 42 and the slice of bread 34. Heat from element 42 travels through the apertured areas (not shown in these figures) in body 12 and toasts that portion of the slice of bread 34 which lies adjacent to the apertured areas 32. Wherever the continuous areas 30 of the design exist, heat is reflected back toward element 42 or is absorbed thereby and the radiated heat is therefore substantially prevented from traveling through body 12 to the slice of bread 34. The portions of the slice of bread 34 adjacent the continuous areas 30 therefore remain substantially untoasted. Consequently, the portions of the slice of bread 34 positioned proximate the apertured areas 32 are browned, while the portions of the slice of bread 34 laying proximate the continuous areas 30 are not browned. These differently browned areas form a replica of the design of heat shield 10 on the slice of bread 34.

When the slice of bread 34 is sufficiently toasted and the toaster carriage 40 moves from the second position (FIG. 6) to the first position (FIG. 5), the user can either lift the slice of toasted slice of bread 34 directly out the toaster 38 in the conventional manner or they can use second flange 24 as a handle to remove the entire heat shield 10 and toasted slice of bread 34.

The shape of shield 10 allows for both ease of use and ease of cleaning of the device.

It will be understood that while the preferred embodiment described above is illustrated as including an second flange 24 which acts as a handle for the body, the body may simply be provided with the first flange 22 which supports a slice of bread thereon. Furthermore, it will be understood that because the heat shield is comprised of only one panel, the orientation of the heat shield within a toaster slot is not relevant other than that the first flange of the heat shield lay in contact with the carriage which moves the bread into and out of the toaster slot.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of the invention are an example and the invention is not limited to the exact details shown or described.

1. A removable heat shield for use in a slot of a toaster for forming a decorative pattern on a baked product, said heat shield comprising:
a single L-shaped panel comprising a body and a flange; and wherein the body has a front and rear surface defined by an upper edge, a lower edge and first and second side edges; and wherein the flange extends outwardly from the body and has a connecting edge attached to the body and an open edge spaced from the body, which open edge is free of any further connections to the body; and wherein the flange is adapted to rest on a movable carriage in the toaster slot and is adapted to receive the baked product thereon; and
a design formed in the body; the design comprising one or more continuous areas decoratively arranged with one or more apertured areas.

2. The removable heat shield as defined in claim 1, wherein the flange extends outwardly away from the front surface of the body and proximate the lower edge thereof.

3. The removable heat shield as defined in claim 2, wherein the flange extends outwardly away from the body at an angle of 90° relative to the front surface thereof.

4. The removable heat shield as defined in claim 3, wherein the body has a width which is measured from the first side edge to the second side edge; and the flange extends outwardly from the body along substantially the entire width thereof.

5. The removable heat shield as defined in claim 4, wherein the flange has a width which is measured from the front face of the body to an outermost edge; and wherein the flange width is sufficiently small enough to be received with the slot of a toaster but sufficiently large enough to support a slice of bread thereon.

6. The removable heat shield as defined in claim 2, further comprising a second flange extending outwardly away from the rear surface of the body.

7. The removable heat shield as defined in claim 6, wherein the second flange extends outwardly from the body proximate the upper edge thereof.

8. The removable heat shield as defined in claim 7, wherein the second flange extends outwardly at an angle relative to the rear surface of the body.

9. The removable heat shield as defined in claim 8, wherein the angle of the second flange relative to the rear surface is between 0° and 90°

10. The removable heat shield as defined in claim 9, wherein the angle of the second flange relative to the rear surface is 45°.

11. The removable heat shield as defined in claim 8, wherein the second flange extends along substantially the entire width of the body.

12. The removable heat shield as defined in claim 11, wherein the second flange includes an aperture through which a consumer's fingers may be received.

13. The removable heat shield as defined in claim 12, further comprising insulation applied around at least a portion of the second flange.

14. The removable heat shield as defined in claim 13, wherein the body and first and second flanges are all substantially flat.

15. The removable heat shield as defined in claim 14, wherein the body and first and second flanges are integrally formed.

16. The removable heat shield as defined in claim 1, wherein the design on the body is a smiling face.

17. The removable heat shield as defined in claim 1, wherein the body is manufactured from one or more of the group consisting of a metal and a heat-resistant plastic.
